(19) United States
(12) Patent Application Publication
(10) Pub. No.: US 2014/0074812 A1
(43) Pub. Date: Mar. 13, 2014

(54) METHOD AND APPARATUS FOR GENERATING A SUGGESTION LIST

(71) Applicant: REDIFF.COM INDIA LIMITED, Mumbai (IN)

(72) Inventors: Gaurav Ruhela, New Delhi (IN); Vishal Shah, Mumbai (IN); Kalpana Banerjee, Chennal (IN); Surabhi Khandavalli, Navi Mumbai (IN)

(21) Appl. No.: 13/926,980

(22) Filed: Jun. 25, 2013

(30) Foreign Application Priority Data
Jun. 25, 2012 (IN) 1820/MUM/2012

(51) Int. Cl. G06F 17/30

(52) U.S. Cl. CPC G06F 17/3097; G06F 17/30864
USPC 707/706; 707/767

(57) ABSTRACT

Embodiments of the present invention provide a method and apparatus for generating a suggestion list. The method includes merging a current set of multiple query candidates (QCs) with two or more historical sets of multiple QCs to obtain two or more corresponding modified sets and merging the two or more modified sets. The current set of multiple QCs is extracted from multiple digital documents (DDs) belonging to a first time period. Each of two or more historical sets of multiple QCs are extracted from multiple DDs corresponding to at least two time periods. Each of the two or more time periods begin prior to the first time period. Each of the two or more time periods is greater that the first time period. Each of the two or more time periods differ in duration and recency.

### CROSS REFERENCE TO RELATED APPLICATIONS

This application claims the benefit of Indian Patent Application titled “Method And Apparatus For Generating A Query Candidate Set” filed on Jun. 18, 2013, which is a non provisional application of the Indian Provisional Patent Application titled “Method and Apparatus for Query Candidate Extraction” filed on Jun. 25, 2012, both having the Application No. 1820/MUM/2012, which are herein incorporated by reference in their entirety.

### BACKGROUND

1. Field of the Invention

Embodiments of the present invention generally relate to search query suggestions, and more particularly, to a method and apparatus for generating a suggestion list.

2. Description of the Related Art

Real time suggestions for query phrases on a retrieval system have various requirements for being effective and useful. For example, the suggested phrase is required to be sensitive to context of the searcher, temporally sensitive and diverse. Further, if data being searched by retrieval system for which the suggestion list is generated has continuous updates, then periodic update of the suggestion list is also required to maintain relevance of the suggestion list with respect to the data being searched. For example, data being searched may be news articles. Since news articles have continuous updates, periodic and regular update of suggestion list for a system searching news articles is required to maintain relevance of the suggestion list. For maintaining a relevant suggestion list huge amount of data needs to be processed and such processing needs to be done on a regular basis for ever-increasing size of data to make the suggestion list temporally relevant.

Furthermore, a suggestion list in most instances includes data that may have different requirements for temporal update. For example, data related to geographical facts such as countries or states and their capitals require to be updated much lesser than current news events. While suggesting a query phrase, such considerations need to be accounted for. Various conventional techniques use ranking or scoring to prioritize the suggestions and the ranking criterion is linked to data that was used as a source for the suggestions which could be historic queries.

However, such techniques of generating suggestion list using ever-increasing size of data suffers the limitation of processing huge amount of data continuously for maintaining context sensitivity, temporal relevancy and diversity in the suggestion list.

Therefore, there is a need for a method and apparatus for generating a suggestion list.

### SUMMARY OF THE INVENTION

Embodiments of the present invention provide a method and apparatus for generating a suggestion list. The method includes merging a current set of multiple query candidates (QCs) with two or more historical sets of multiple QCs to obtain two or more corresponding modified sets and merging the two or more modified sets. The current set of multiple QCs is extracted from multiple digital documents (DDs) belonging to a first time period. Each of two or more historical sets of multiple QCs are extracted from multiple DDs corresponding to at least two time periods. Each of the two or more time periods begin prior to the first time period. Each of the two or more time periods is greater that the first time period. Each of the two or more time periods differ in duration and recency.

### BRIEF DESCRIPTION OF THE DRAWINGS

FIG. 1 depicts a schematic diagram of a system for generating a suggestion list;

FIG. 2 depicts a schematic diagram of a suggestion list generator of FIG. 1 according to an embodiment of the present invention;

FIG. 3 depicts a functional block diagram of generating a suggestion list according to an embodiment of the present invention;

FIG. 4 depicts a flow diagram of generating a suggestion list according to an embodiment of the present invention; and

FIGS. 5a and 5b depict exemplary screenshots illustrating proposed query list rendered in response to at least part search query, according to an embodiment of the present invention.

While the method and apparatus is described herein by way of example for several embodiments and illustrative drawings, those skilled in the art will recognize that the method and apparatus for generating a suggestion list are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for generating a suggestion list as illustrated by various embodiments. Any headings used herein are for organizational purposes only and are not meant to limit the scope of the description or the embodiments. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention comprise a method and apparatus for generating a suggestion list. The technique described herein generates a suggestion list in response to receiving part or full search query on a search engine. The suggestion list comprises query candidates extracted from digital documents. According to an embodiment, the query candidates are sequences of words similar to search queries received on a search engine. According to an embodiment, the query candidates may be generated by query candidate generating method described in Indian patent application number 1820/MUM/2012, titled ‘Method and apparatus for query candidate extraction’ and Indian patent application number 1833/MUM/2012 titled ‘Method and apparatus for presenting relevant articles and representative information thereof’ incorporated herein by reference in their entirety. The query candidates included in the suggestion list and order of presentation of the query candidates in the suggestion list are temporally sensitive. Temporal sensitivity of the suggestion list is maintained by continuously updating the suggestion list by extracting data from recent digital documents and scoring the query candidates according to recency of the digital documents. Data processing for such updates is a cumbersome task due to size of data involved.

The technique for generating the suggestion list described herein advantageously uses an incremental approach of update. Separate sets of query candidates are extracted using digital documents belonging to different time periods. Each query candidate of each of the sets are scored. Those skilled in the art will appreciate that the scores may be used for ranking the QCs. For example, a QC with highest score among multiple QCs assigned the score may be considered to have the highest rank and similarly other QCs having score lower than the highest score may form an ordered list in descending order of score and rank. Subsequently, scored query candidate sets are merged. The scoring of query candidates is tuned such that merging of the sets provides a temporally sensitive and diverse suggestion list. The incremental approach of update described herein specifically involves merging each of two or more historical query candidate sets generated from digital documents from two or more time periods that differ in duration and recency with a current set of query candidates generated from digital documents belonging to a first time period to obtain two or more corresponding modified query candidate sets. The two or more time periods of digital documents used for extracting the two or more historical query candidate sets begin prior to the first time period and are greater than the first time period. The two or more modified query candidate sets are merged according to the score of each if the query candidates, to generate the suggestion list. Such incremental approach is repeated at regular intervals to maintain temporal sensitivity of the suggestion list.

In the following detailed description, numerous specific details are set forth to provide a thorough understanding of the disclosed subject matter. However, it will be understood by those skilled in the art that disclosed subject matter may be practiced without these specific details. In other instances, methods, apparatuses or systems that would be known by one of ordinary skill have not been described in detail so as not to obscure disclosed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the art or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

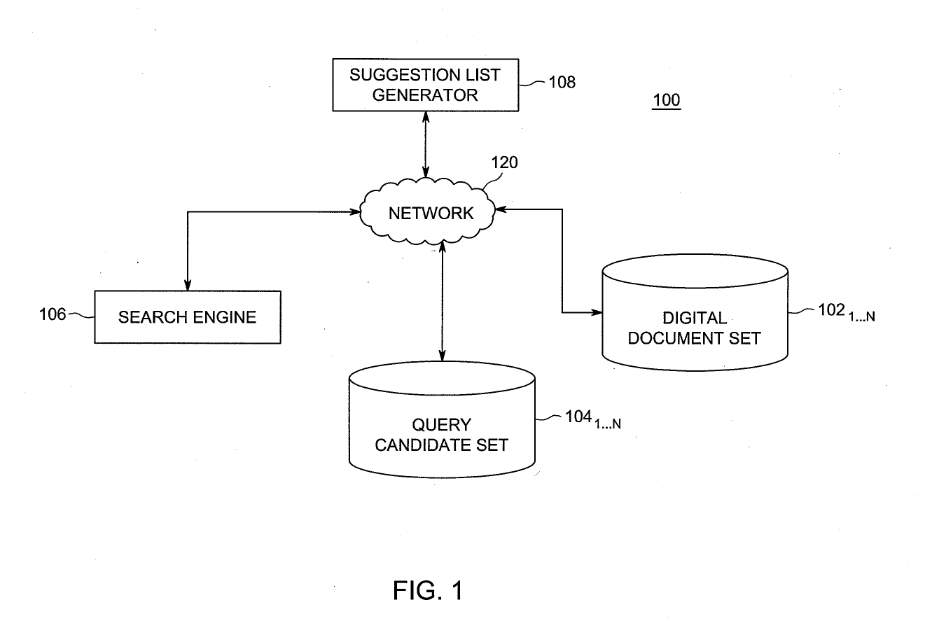

Embodiments of the present invention provide a method and apparatus for generating a suggestion list. FIG. 1 depicts a block diagram depicting a system 100 for generating a suggestion list according to one or more embodiments of the invention. The system 100 comprises multiple digital document (DD) sets 102, (multiple DD corpuses illustrated in FIG. 1 by numerals 102₁, . . . 102ₙ), multiple query candidate (QC) sets 104, (multiple QC sets illustrated in FIG. 1 by numerals 104₁ . . . ₙ) a search engine 106, a suggestion list generator 108 and a network 120.

In some embodiments, the network 120 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface may support communication via wired or wireless general data networks, such as any suitable type of Ethernet network, for example; via telecommunications/telephony networks such as analog voice networks or digital fiber communications networks; via storage area networks, such as Fiber Channel SANs, or via any other suitable type of network and/or protocol.

The multiple DD sets 102, the multiple QC sets 104, the search engine 106 and the suggestion list generator 108 are computing devices configured for exchanging digital content over the network 120, processing and displaying such content and providing a user interface. The multiple DD sets 102 include computing devices storing digital documents (DDs), for example news articles, Wikipedia articles, shopping catalogues, job listings and metadata related to the DDs and the like. Each of the multiple DD sets have DDs belonging to different time periods. The time periods for each of the multiple DD sets differ in duration and recency. According to one embodiment, the multiple DD sets 102 may comprise a first DD set, a second DD set and a third DD set. The first DD set may comprise multiple DDs belonging to a first time period (for example, past one hour). The second DD set may comprise multiple DDs belonging to a second time period (for example, beginning one day prior to the first time period). The third set may comprise multiple DDS belonging to a third time period (for example, beginning one year prior to the first time period).

The multiple QC sets 104 include computing devices storing multiple QCs extracted from one DD set from the multiple DD sets 102. According to one embodiment, the multiple QC sets 104 may comprise a first QC set or current set, and two or more historical sets, for example, a second QC set and a third QC set. The current set includes multiple QCs extracted from multiple DDs of the first DD set. Similarly, the second QC set comprises multiple QCs extracted from multiple DDs of the second DD set and the third QC set comprises multiple QCs extracted from multiple DDs of the third DD set. The search engine 106 is a computing device from which a search query is received, and to which a results of the search query processing may be displayed.

The suggestion list generator 108 generates a suggestion list and renders the suggestion list in response to a prefix of a search query being received on the search engine 106. The suggestion list generator 108 generates the suggestion list using the multiple QC sets 104. Those skilled in the art will appreciate that the various functionalities of the multiple DD sets 102, the multiple QC sets 104, the search engine 106 and the suggestion list generator 108 can be configured differently, for example, using the devices of the system 100 for different functionality, or using other devices communicably coupled to the network 120 to achieve these functionalities, and similar such configurations, all of which are included within the scope and spirit of the invention.

According to some embodiments, the apparatus 100 includes a component extracting module (not shown) implemented by a technique generally known in the art for extracting the text, images and other components from the digital document. In some embodiments, the component extracting module downloads actual URL of the digital document to obtain entire content of the digital document to use for extracting, indexing, searching and scoring. The component extracting module specifically analyzes the DOM structure of the HTML of the digital document, and extracts text of the digital document. In the process, the component extracting module strips out irrelevant components of the digital document such as advertisements, navigational links, user comments, and the like. The text extracted by the component extracting module is used to extract query candidates as explained in detail below.

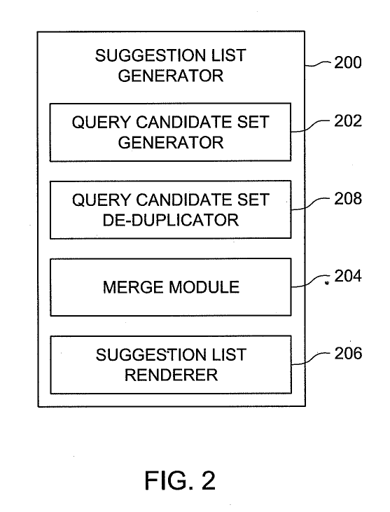

FIG. 2 depicts a block diagram of a suggestion list generator 200 for generating the suggestion list, similar to the suggestion list generator 108 of FIG. 1, according to one or more embodiments of the invention. In some embodiments, the suggestion list generator 200 is a type of computing device (e.g., a laptop, a desktop, a Personal Digital Assistant (PDA) and/or the like) known to one of ordinary skill in the art. The suggestion list generator 200 comprises a QC set generator 202, a QC set de-duplicator 208, a merge module 204 and a suggestion list renderer 206.

According to an embodiment, the QC set generator 202 is implemented by a QC generating method described herein. The QC generating method includes extracting sequence of words (for example, phrase, clause and sentence) and tagging (using an automated parts of speech tagger) the sequence of words to obtain a sequence of tags, comparing the sequence of tags with one or more reference sequences and selecting the sequence of words as QC if the sequence of tags matches with the one or more reference sequences. The one or more reference sequences are obtained by tagging search queries received by an automated search retrieval system, such a web based search engine. Further, the QC set generator 202 includes a scorer (not shown) for assigning a score to each of the multiple QCs generated. According to an embodiment, the QCs may be scored as is described in Indian patent application number 1820/MUM/2012, titled ‘Method and apparatus for query candidate extraction’ and Indian patent application number 1833/MUM/2012 titled ‘Method and apparatus for presenting relevant articles and representative information thereof’ incorporated herein by reference in their entirety. Techniques such as Hadoop map-reduce framework, generally known in the art for large scale data processing is used. The scorer assigns the score according to one or more features of the QC. The one or more features may be obtained from metadata associated with each DD. The one or more features comprise one of term frequency (representing number of times the QC appears in the DDs of the DD Set of a particular time period), document frequency (representing number of DDs in the DD set of a particular time period containing one or more occurrences of the QC), whether or not words of the QC are named entity, length of the QC, position of the QC in the digital document (for example, title, beginning of description etc.), credibility (for example, publisher credibility, impact factor of scientific journals, website credibility etc.) of the DD from which the QC is extracted, country of origin of the DD from which the QC is extracted, criticality of subject matter of DD from which the QC is extracted, category of subject matter (such as sports, entertainment, weather or several other categories as will occur to those skilled in the art) of DD from which the QC is extracted, recency of the DD from which the QC is extracted, number of DD from which the QC is extracted originating from preferred country, number of DD from which the QC is extracted having global relevance. Further, each of these features may have a weightage for score calculation. Each of the one or more features contributes to computing the score for each QC. The scorer computes a score for each QC by taking weighted importance of the one or more features. For example, if a feature has a value of S1 for a QC C1, the score of the QC C1 is function of f(WF1*S1), where WF1 is the weight of the feature. Such scoring provides a means for identifying and selecting QCs based on preferred features. For example, recency of the DD is given a higher weightage for capturing QCs that are currently important.

Included feature of recency of the DD provides for distinguishing the more recent DD. Similarly, included feature of country of origin provides for a comparative analysis between preferred country and global articles and understand the relevance of a QC with respect to India and the world. Such comparison is a part of the identifying and/or introducing a regional bias. Those skilled in the art will appreciate that a QC can always be important or a QC may have temporal (limited by time) importance. A QC which is of importance almost always is expected to have constant value for features and such QCs may be related to subjects covered in DDs every day. QCs with temporal importance may be QCs which are related to current on-going activity or event or news and may show rise in value of one or more features temporarily and are likely to become less important over time. Scoring and merging according to score, QCs extracted from time periods of different duration and recency facilitates appropriate recognition of temporally important QCs and QCs having constant importance. Extracting QCs from DDs belonging to short and recent time period facilitates capturing the temporary rise in significance of the QC. Conversely, extracting QCs from DDs belonging to long and old time period facilitates capturing the QCs having constant importance.

According to some embodiments, the QC set de-duplicator 208 checks each QC set generated by the QC set generator 202 for QCs that are syntactic variations of each other. If the QC set has multiple QCs which are syntactic variations of each other, QC having highest score among all the syntactic variations is selected and other syntactic variations are eliminated from the QC set. for example, ‘death of Osama’ and ‘Osama's death’, which are identified as syntactic variations of each other, are considered equivalent QCs. Syntactic variations of QCs may be recognized by natural language processing techniques generally known in the art. For example, two QCs ‘Indian cricketers’ and ‘Cricketers of India’ are identified as syntactic variations of each other and the QC set de-duplicator 208 eliminates one of the two equivalent QCs having lower score. Such natural language processing techniques used for obtaining and identifying syntactic variations of the QC may include rotation of words and translation of possessive apostrophe among others. Rotation of words is generally implemented between pairs of words and includes change in order of words in the QC. For example, QC ‘mars discovery’ and QC ‘discovery mars’ are rotated syntactic variations of each other. The QC set de-duplicator 208 may select ‘mars discovery’ having higher score because of feature of term frequency and eliminate ‘discovery mars’ from the QC set. Similarly, QC ‘death of Osama’ and QC ‘Osama's death’ are translated syntactic variations of each other. The QC set de-duplicator 208 may select ‘death of Osama’ or ‘Osama's death’ whichever has higher score in the QC set and eliminates the other. Including QC having highest score from among syntactic variations of QCs and eliminating others ensures inclusion of QC having highest representation in the DDs, thereby biasing the QC set to contain QCs that may enable a successful search.

The merge module 204 merges two or more historical sets of QCs from the multiple QC sets 104 by merging with the current set generated using a DD set of the most recent and shortest time period from for example, the multiple DD set 102 to obtain corresponding two or more modified sets. Subsequently the two or more modified sets are merged to generate the suggestion list. The merging module is implemented by a method 400 described in detail below. Refreshing data by merging processed data (i.e. scored query candidates) from a recent and short time period to processed data from a prior longer duration reduces expense (in terms of time and effort) of processing large amount of data, while maintaining temporal sensitivity of the data. Accordingly, the merge module 204 merges each of two or more historical sets generated from DDs belonging to two or more time periods differing in recency and duration with the current QC set generated using the DD set of a first time period to obtain two or more modified QC sets. The merge module 204 merges according to score of each of the multiple QCs of each of the current set and the two or more historical sets. The first time period is more recent and shorter than the two or more time periods. Further, the merge module 204 merges the two or more modified QC sets according to the score of each of the multiple QCs of each of the modified QC sets to generate the suggestion list. The suggestion list generated by such merging comprises multiple QCs ordered according to the score.

The suggestion list renderer 206 renders a proposed query list in response to each keystroke of search query received on the search engine by retrieval techniques based on prefix matching or substring match generally known in the art. The proposed query list includes multiple QCs in descending order of the score from the suggestion list according to content of the received search query, for example, the search engine 106 of FIG. 1. As described above, QC having highest score is rendered foremost. According to an embodiment, the proposed query list is filtered to remove substantially similar QCs before being rendered. Filtering of the proposed query list ensures diversity in QCs suggested to the user with each keystroke of search query and is described below in detail. Further, the number of multiple QCs included in the proposed query list may be predetermined to a specific number or may be defined as a range of minimum and maximum number.

According to an embodiment, filtering includes checking each QC in the proposed query list subsequent to foremost QC in the proposed query list (having highest score) for diversity with respect to one or more prior QCs in the proposed query list. Various techniques may be used for checking for diversity and one or more QCs are eliminated from the proposed query list if one or more similarity criterion is met. The one or more similarity criterion include one of, the one or more QCs are tokenized form of the one or more prior QCs, the one or more QCs are a spell variant of the one or more prior QCs and number of words common between with the one or more prior QCs is less than number of words of the at least part search query. One technique for checking diversity includes comparing tokenized form. The tokenized form may include first 5 characters of each word of the QC. For example, if the one or more prior QCs is ‘Indian cricketers’ and has a tokenized form of ‘india.crick’, QCs like Indian cricketers, ‘Indian cricket’ having the same tokenized is eliminated from the proposed query list. Another technique for checking diversity includes replacing double letters in words of the one or more QCs. If after replacing double letters with single letter, the one or more QCs do not differ, the one or more QCs with highest score is preserved while is eliminating those with lower score from the proposed list. For example, if one or more prior QCs of the proposed query list (having higher score) is ‘mamata bannerjee’, the one or more QCs like ‘mamta bannerjee’ and ‘mamata banerjee’ are eliminated. Yet another technique for checking diversity includes comparing number of words common in the one or more QCs and number of words of the at least part search query received. The one or more QCs are preserved in the proposed query list if difference in number of words common and the number of words in the at least part search query received does not exceed a predefined level. For example if the predefined level is 2, the one or more QCs are preserved in the proposed query list if the following formula holds true:

(nMatched−nPrefixWords)<2 where,
nMatched is number of words common in the QC and the one or more prior QCs and nPrefixWords is word count in the at least part search query received.

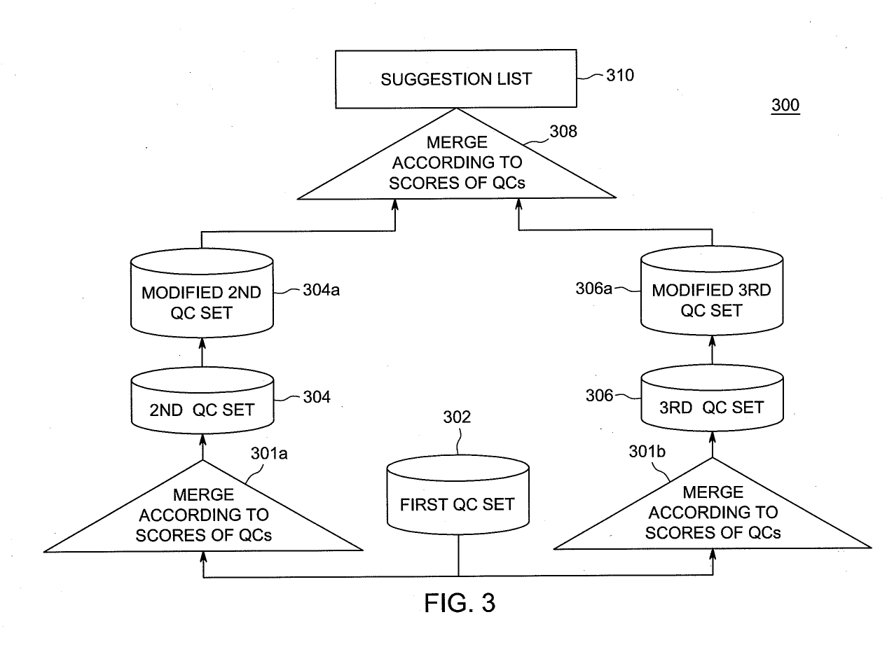

FIG. 3 depicts a functional block diagram of generating a suggestion list, according to an embodiment of the invention. According to the embodiment illustrated in FIG. 3 and considering same example as described above, the multiple QC sets, for example the multiple QC sets 104 of FIG. 1 may include the current set or the first QC set 302, the second QC set 304 and the third QC set 306. The two or more historical sets may comprise the second QC 304 set and the third QC set 306. Accordingly, the merge module 204 merges each of the second QC set 304 and the third QC set 306 with the first QC set 302 generated from DDs of the first time period, depicted as 301a and 301b, respectively, to obtain a modified second set 304a and a modified third set 306a. Also, as described above, each QC of each QC set, the second QC set 304, the third QC set 306 and the first QC set 302 generated using the DDs of the first time period is scored according to the one or more features. Subsequently the modified second QC set 304a and the modified third QC set 306a are merged by for example, by the merging module 204 according to the score of each of the multiple QCs of the modified second QC set 304a and the modified third QC set 306a, at 308 to generate the suggestion list 310. For example, the first time period may be past one hour and the second QC set 304 and the third QC set 306 may be generated from DDs of the two or more time periods, for example beginning 24 hours prior to the first time period and beginning one year prior to the first time period respectively. Those skilled in the art will appreciate that such merging of the first QC set 302 generated using DDs of the first time period that is shorter and more recent than the two or more time periods provides advantage of data processing efficiency while maintaining temporal relevancy in the suggestion list generated. The first QC set 302 generated from the DDs of the first time period comprises multiple QCs scored according to the one more features. Among other features, feature of term frequency enables capturing QCs occurring with highest frequency in the DDs of the first time period. Such QCs belong to most recently relevant DDs and represent recently relevant content. Merging such QC set generated using the first time period temporally refreshes or updates the second QC set 304 and the third QC set 306. Further such merging also enables efficient processing of large amount of data. For example, instead of processing the whole data with new data being added every hour over and over, every hour to maintain temporal relevancy, the technique of merging the first QC set 302 generated using DDs of the past one hour with the previously obtained second QC set 304 and third QC set 306 saves processing time and effort. Only the latest one hour DDs may be processed for generating QCs and scoring the QCs.

The second QC set 304 and the third QC set 306 are described here only as an example of the two or more QC sets. The two or more QC sets may comprise any number of QC sets for example, 4 QC sets, according to desired temporal relevance of the suggestion list and data processing requirement and capability. Those skilled in the art will appreciate that the second QC set 304 and the third QC set 306 provide QCs obtained from DDs of longer and time periods beginning prior than the first time period, thereby infusing QCs in the suggestion list having relevance over longer and older periods of time. QCs from DDs belonging to longer and older time periods facilitate capturing content having relevance over longer periods. Therefore, number of two or more QC sets and the duration of each of the first time period and the DDs of the two or more QC sets may be selected based on desired temporal relevance of the suggestion list. For example, if an extremely important event is known to have occurred, and the suggestion list is desired to be relevant in real time, the first time period may be selected to be half an hour and the QC set generated from DDs of the past half an hour may be merged with the two or more QC sets. Further such technique of merging the two or more QC sets with QCs generated from past half hour may be performed every half an hour to keep the suggestion list temporally relevant near real time.

According to an embodiment, such technique of refreshing data by merging processed data from a recent and short time period to processed data from the two or more time periods beginning prior and longer in duration is repeated at regular intervals to maintain temporal relevance of the suggestion list. For example, consider two instances of generating the suggestion list at an interval of one hour with the two or more historical sets of multiple QCs comprising the second QC set 304 and the third QC set 306. The first time period comprises 1 hour. The second QC set 304 and the third QC set 306 may be generated from DDs belonging to time period beginning 24 hours prior to the first time period and time period beginning one year prior to the first time period. The first instance of generation of suggestion list may be performed at for example, 9 A.M. on 4 May 2013. Accordingly, the first time period would be 8 A.M. to 9 A.M. on 4 May 2013, the time period of the DDs used for generating the second QC set 304 may begin at 8 A.M. 3 May 2013 and the time period of the DDs used for generating the third QC 306 set may begin at 8 A.M. 3 May 2012. According to one embodiment, the time period of the DDs used for generating the second QC set 304 may end at 8 A.M. 4 May 2013 and the time period of the DDs used for generating the third QC set 306 may end at 8 A.M. 3 May 2013. Alternately, the time period of the DDs used for generating the second QC set 304 may end at 9 A.M. 4 May 2013 and the time period of the DDs used for generating the third QC set 306 may end at 9 A.M. 3 May 2013. The current set of multiple QCs are merged with each of the second QC set 304 and the third QC set 306 to obtain the modified second QC set 304a and the modified third QC set 306a. The modified second QC set 304a and the modified third QC set 306a are merged to generate the suggestion list 310 at the first instance. Continuing the same example, the second instance of generation of the suggestion list 310 would be performed at 10 A.M on 4 May 2013. Accordingly, the first time period would be 9 A.M. to 10 A.M. on 4 May 2013, the time period of DDs for generating the second QC set 304 would be 9 A.M. 3 May 2013 to 9 A.M. 4 May 2013 and the time period of the third QC set 306 would be 9 A.M. 3 May 2012 to 9 A.M. 3 May 2013. According to an embodiment, generation of the suggestion list 310 at the second instance includes merging QCs generated from DDs belonging to the first time period (shifted by an hour) with each of the second QC set 304 (shifted by an hour) and the third QC set 306 (shifted by an hour) to obtain modified second QC set 304a and modified third QC set 306a. Again, the modified second QC set 304a and the modified third QC set 306a are merged to generate the suggestion list 310 at the second instance. Those skilled in the art will appreciate that, time period of longest of the at least two time periods, for example the third QC set 306, may not be shifted by an hour and may include the first time period as duration of first time period may be too small to make significant changes in data.

According to another embodiment, generation of the suggestion list 310 at the second instance includes merging the modified second QC set 304a obtained at first instance of generation of the suggestion list and the modified third QC set 306a obtained at first instance of generation of the suggestion list, with QC set generated by using DDs of a second time period. The second time period begins at the end of the first time period and may be equal of different in duration than the first time period. . For example, considering the same example described above, the second time period may be 10 A.M. to 11 A.M. on 4 May 2013 and multiple query candidates extracted using DDs belonging to the second time period may be merged to the modified second QC set 304a obtained at first instance of generation of the suggestion list and the modified third QC set 306a obtained at first instance of generation of the suggestion list. However, those skilled in the art will appreciate that the two or more modified QC sets are available after first instance of suggestion list generation and therefore such merging with the modified two or more QC sets, is possible only in instances of generation of suggestion list following the first instance.

Those skilled in the art will appreciate that due to approximations in scoring function used while generating the suggestion list according to the merging technique of incrementally processed data described above, the suggestion list gradually deviates from ideal suggestion list that would be generated if QCs are obtained and scored from data which includes DDs of entire time period including the most recent and shortest time period (the first time period). To overcome such deviations the ideal suggestion list may be re-generated at predefined and regular intervals. Alternately, deviations may be overcome by re-generating, one or more of the two or more QC sets from DDs of time period including the most recent and shortest time period. For example the third QC set 306 may be not be modified by merging with the QCs obtained from DDs of the first time period. Instead, the third QC set may be re-generated from DDs including the DDs of the first time period added to DDs of the third time period. Such re-generation ensures that the scoring function does not need to do any approximations while scoring the third QC set. Subsequently, the re-generated third QC set 306 may be merged with the modified second QC set 304a to generate the suggestion list 310. Furthermore, those skilled in the art will appreciate though temporal sensitivity and diversity of the suggestion list may be affected and compensated, the technique of generating the suggestion list 310 described herein, by merging QCs obtained from DDs of short and recent time period with QCs obtained from DDs of longer and prior time periods provides flexibility of using only one of the two or more QC sets, if one or more of the two or more QC sets are temporarily unavailable.

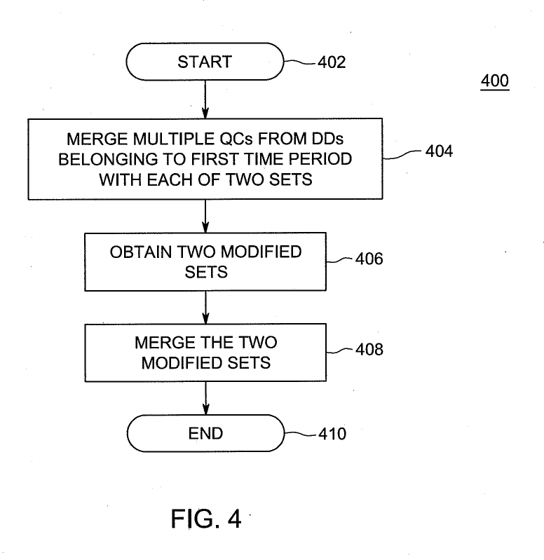

FIG. 4 depicts a flow diagram of a method for generating a suggestion list, according to one or more embodiments of the invention. The method 400 starts at step 402, and proceeds to step 404. At step 404, the method 400 merges at least two QC sets with the first QC set to obtain at least two modified QC sets at step 406. Considering the same example of the first QC set extracted using DDs of the first time period, the second QC set extracted using DDs of the second time period and the third QC set extracted using DDs of the third time period described above in reference to FIG. 1. At step 404, the method 400 merges the second QC set with the first QC set and the third QC set with the first QC set to obtain, at step 406, a modified second QC set and a modified third QC set. At step 408, the method 400 merges the at least two modified QC sets for example, the modified second QC set and the modified third QC set. The method 400 proceeds to step 410 and ends. The first QC set being merged to the second QC set and the third QC set is only described here as an example and not as a limitation. The at least two QC sets may comprise n number of QC sets and at step 404, each of these n number of QC sets are merged with the QC set extracted from DDs belonging to the most recent and shortest time period. Subsequently, each of these n modified QC sets are merged at step 408 to generate the suggestion list. Further steps 402 through 410 may be repeated regularly or at predefined intervals by shifting the first time period to a more recent time period to maintain temporal relevance of the suggestion list. According to one embodiment, if the method 400 is an instance of generation of the suggestion list following the first instance of generation of the suggestion list (for example, the second instance), at step 404, the method 400 merges the modified second QC set (obtained from first instance of suggestion list generation) with the first QC set and the modified third QC set (obtained from first instance of suggestion list generation) with multiple QCs extracted from DDs belonging to the second time period, at step 406. Alternatively, instances of suggestion list generation following the first instance of suggestion list generation may follow the steps 402 through 410 as described earlier.

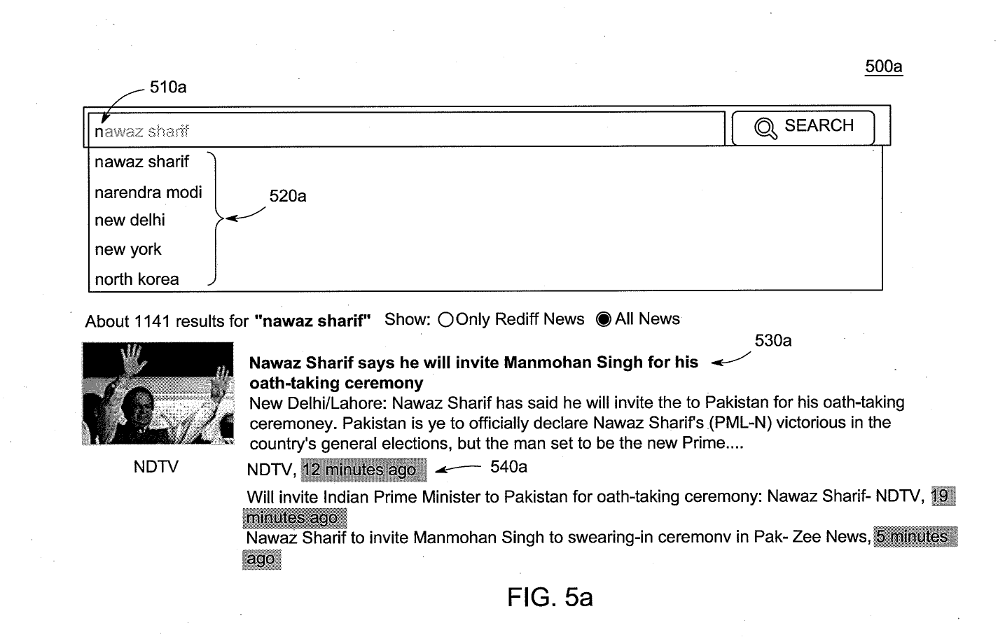

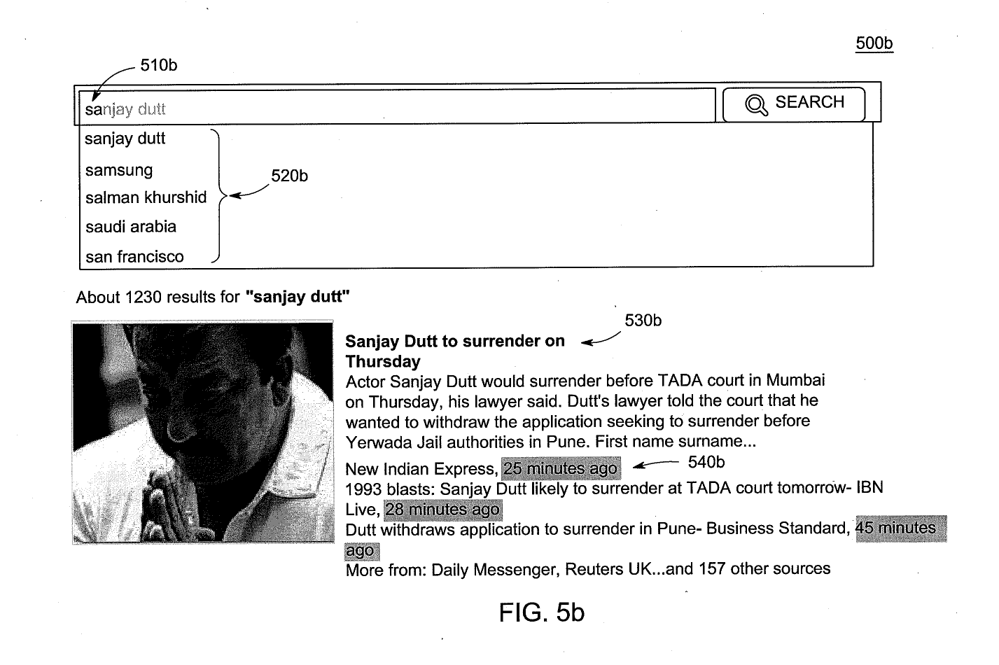

FIGS. 5a and 5b depict exemplary screenshots illustrating proposed query list rendered in response at least part search query, according to one or more embodiments of the present invention. FIG. 5a depicts a user interface (UI) 500a of a search engine for an automated retrieval system. The UI 500a includes at least part search query 510a, the proposed query list 520a, search result 530a and time of inclusion 540a. When a single keystroke ‘n’ of the at least part search query 510a is received by the search engine, the proposed query list 520a is rendered on the GUI 500a. The proposed query list 520a includes multiple QCs (5 QCs in the illustrated example) and each of the 5 QCs contain diverse information. Further, search result 530a depicts search result for foremost QC presented in the proposed query list 520a rendered in response to the at least part search query 510a and according to content of the at least part query 510a. The time of inclusion 540a depicts time elapsed from inclusion of the digital document pulled up as search result for the foremost query ‘nawaz sharif’ in the digital documents being searched. Those skilled in the art will appreciate that the proposed query list 520a is temporally relevant as the search result for foremost QC (having highest score) relates to a digital document added to the digital documents being searched within previous 20 minutes.

Similarly, FIG. 5b depicts GUI 500b of a search engine for an automated retrieval system. The GUI 500b includes at least part search query 510b, the proposed query list 520b, search result 530b and time of inclusion 540b. When the keystrokes ‘sa’ of the at least part search query 510b is received by the search engine, the proposed query list 520b is rendered on the UI 500b. The proposed query list 520b includes multiple QCs (5 QCs in the illustrated example) and each of the 5 QCs contain diverse information. Further, search result 530b depicts search result for foremost QC presented in the proposed query list 520b rendered in response to the at least part search query 510b and according to content of the at least part query 510b. The time of inclusion 540b depicts time elapsed from inclusion of the digital document pulled up as search result for the foremost query ‘sanjay dutt’ in the digital documents being searched. Those skilled in the art will appreciate that the proposed query list 520b is temporally relevant as the search result for foremost QC (having highest score) relates to a digital document added to the digital documents being searched within previous 30 minutes.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated. In some embodiments, the illustrated computer system may implement any of the methods described above, such as the methods illustrated by the flowcharts of FIG. 4. In other embodiments, different elements and data may be included.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of the invention. Finally, structures and functionality presented as discrete components in the example configurations may be implemented as a combined structure or component. These and other variations, modifications, additions, and improvements may fall within the scope of embodiments as defined.

The foregoing is directed to embodiments of the present invention, other and further embodiments of the invention may be devised without departing from the basic scope thereof.

What is claimed is:

1. An apparatus for generating a suggestion list, the apparatus comprising:
a merge module for merging a current set of plurality of query candidates (QCs) with at least two historical sets of a plurality of query candidates (QCs) to obtain at least two corresponding modified sets, the current set of plurality of QCs extracted from a plurality of digital documents (DDs) belonging to a first time period, and each of the at least two historical sets of plurality of QCs extracted from DDs corresponding to at least two time periods, wherein each of the at least two time periods begin prior to the first time period, each of the at least two time periods is greater than the first time period, and each of the at least two time periods differ in duration and recency; and
merging the at least two modified sets.

2. The apparatus of claim 1, further merges a plurality of QCs extracted from a plurality of DDs belonging to a second time period with the at least two modified sets of plurality of QCs, wherein the second time period begins at end of the first time period.

3. The apparatus of claim 1, wherein the first time period comprises a past hour.

4. The apparatus of claim 1, wherein at least one of the at least two time periods begins 24 hours prior to the first time period.

5. The apparatus of claim 1, wherein each of the plurality of QCs is assigned a score computed according to at least one feature of each of the plurality of QCs.

6. The apparatus of claim 5, wherein the merge module merges according to the score of each of the plurality of QCs being merged.

7. The apparatus of claim 5 further comprising a query candidate set de-duplicator for identifying at least two equivalent QCs from the plurality of QCs of the current set and of each of at least two historical sets, the at least two equivalent QCs being syntactic variations of each other.

8. The apparatus of claim 7 wherein the de-duplicator replaces the at least two equivalent QCs with one of the at least two equivalent QCs having highest score.

9. The apparatus of claim 5, further comprising a suggestion list renderer for rendering a proposed query list comprising a plurality of QCs selected from the suggestion list in descending order of the score, in response to receiving at least part search query on a search engine and according to content of the search query.

10. The apparatus of claim 9, wherein one or more QCs of the proposed query list are eliminated prior to rendering the proposed query list if at least one similarity criterion is met, the similarity criterion comprising the one or more QCs are tokenized form of one or more prior QCs of the proposed query list, the one or more QCs are a spell variant of the one or more prior QC of the proposed query list, or number of words common between the one or more QCs and the one or more prior QCs of the proposed query list is less than number of words of the at least part search query.

11. A method for generating a suggestion list, the method comprising:
merging, using a merge module, a current set of plurality of query candidates (QCs) with at least two historical sets of a plurality of query candidates (QCs) to obtain at least two corresponding modified sets, the current set of plurality of QCs extracted from a plurality of digital documents (DDs) belonging to a first time period, and each of the at least two historical sets of plurality of QCs extracted from a plurality of DDs corresponding to at least two time periods, wherein each of the at least two time periods begin prior to the first time period, each of the at least two time periods is greater than the first time period, and each of the at least two time periods differ in duration and recency; and
merging, using the merge module, the at least two modified sets.

12. The method of claim 11, further comprising merging a plurality of QCs extracted from a plurality of DDs belonging to a second time period with the at least two modified sets of plurality of QCs, wherein the second time period begins at end of the first time period.

13. The method of claim 11, wherein the first time period comprises a past hour.

14. The method of claim 11, wherein at least one of the at least two time periods begins 24 hours prior to the first time period.

15. The method of claim 11, wherein each of the plurality of QCs is assigned a score computed according to at least one feature of each of the plurality of QCs.

16. The method of claim 15, wherein the merging is performed according to the score of each of the plurality of QCs being merged.

17. The method of claim 15, further comprising identifying at least two equivalent QCs from the plurality of QCs of the current set and of each of at least two historical sets, the at least two equivalent QCs being syntactic variations of each other and replacing the at least two equivalent QCs with one of the at least two equivalent QCs having highest score.

18. The method of claim 15 further comprising rendering a proposed query list comprising a plurality of QCs selected from the suggestion list in descending order of the score, in response to receiving at least part search query on a search engine and according to content of the search query.

19. The method of claim wherein one or more QCs of the proposed query list are eliminated prior to rendering the proposed query list if at least one similarity criterion is met, the similarity criterion comprising the one or more QCs are tokenized form of one or more prior QCs of the proposed query list, the one or more QCs are a spell variant of the one or more prior QC of the proposed query list, or number of words common between the one or more QCs and the one or more prior QCs of the proposed query list is less than number of words of the at least part search query.

20. A non-transient computer readable storage medium for storing computer instructions that, when executed by at least one processor cause the at least one processor to perform a method for generating a suggestion list, the method comprising:
merging, using a merge module, a current set of plurality of query candidates (QCs) with at least two historical sets of a plurality of query candidates (QCs) to obtain at least two corresponding modified sets, the current set of plurality of QCs extracted from a plurality of digital documents (DDs) belonging to a first time period, and each of the at least two historical sets of plurality of QCs extracted from a plurality of DDs corresponding to at least two time periods, wherein each of the at least two time periods begin prior to the first time period, each of the at least two time periods is greater than the first time period, and each of the at least two time periods differ in duration and recency; and
merging, using the merge module, the at least two modified sets.
